(19) United States
(12) Patent Application Publication
(10) Pub. No.: US 2005/0171819 A1
(43) Pub. Date: Aug. 4, 2005

(54) Web-based claims processing method and system

(76) Inventors: Victoria A. Keaton, Indianapolis, IN (US); Adari Venkata Siva Satyanarayana, Manhattan, KS (US)

Correspondence Address: Gregory P. Gadson, Esq., 19375 Amber Way, Noblesville, IN, 46060, US

(21) Appl. No.: 10/770,168

(22) Filed: Feb. 2, 2004

(51) Int. Cl. G06F 17/60

(52) U.S. Cl. 705/4

(57) ABSTRACT

A novel electronic claims coding, billing and processing method and system specially adapted for processing insurance-related claims obviates the need for prior art faxing, telephoning and mailing of insurance claim information from service providers, and for electronic systems, eliminates the need for specialized or proprietary software for service providers. Broadly, the present invention provides a method of coding, billing and processing insurance claims that at least includes: a) via a first entity (such as a service provider), electronically gathering information comprising an insurance claim; b) connecting a front end first computer under the dominion of the first entity to a back end second computer under the dominion of a claims processing entity via the World Wide Web; c) transmitting an insurance claim from the first computer to the second computer via the World Wide Web; d) via the second computer, automatically processing the insurance claims; and e) via the claims processing entity, presenting processed insurance claims information to an insurer entity subsuming the responsibilities of deciding whether to pay a claim and payment of a claim.

### FIELD OF THE INVENTION

The present invention broadly relates to claims processing and health information management. More particularly, the present invention relates to improvements in electronic health information management and claims processing methods and systems that are compatible with the Health Information Portability and Accountability Act of 1997 (“HIPAA”).

### BACKGROUND OF RELATED ART

The security, privacy, and health information aspects of insurance claim coding, billing and processing increasingly consume more resources of a medical practitioner's office—especially with HIPAA guidelines. In order to comply with HIPAA, satisfy other requirements, and reduce paper-work, many in the chain of claims coding, billing and processing functions have sought to reduce the associated cost and time burdens involved.

To introduce more efficiency in claims coding, billing and processing, intermediary agents often process or pre-process claims received from service providers before the claims are presented to the insurance company (the “payor” or “payer”) for final decisions on the payment of the claim. Currently, the insurance claims processing agent receives a claim or claim information on required or predefined claim forms, layouts and the like. In more basic systems, such as the one 100 illustrated in FIG. 1, the claim forms are transmitted from a service provider 110 to a claims coding, billing or processing agent 120 by mail (140) or facsimile machine (via elements 150 and 160).

Upon receipt of patient benefit verification of insurance and the claim information (whether on a “super bill,” “charge slip,” or “operating report,” for example), an employee of the claims billing, coding and processing agent 120 can transcribe the information and place it into the correct hardcopy form or electronic file and format form. The aforementioned employee or others of the claims billing, coding and processing agent 120 can then prepare or preprocess the claim as is necessary. The coded, compliant claim (as is required by regulations and the specific requirements of the Third Party Payor) is then presented to the Third Party Administrator (also known as the payor/insurer) 130 for payment or other final processing.

A variation on the mail and facsimile versions of prior art claims processing systems reduces the paper and paperwork somewhat by electronically transferring claims from a service/medical provider's computer 170 directly to the claims coding, billing and processing agent 120 via a modem link (symbolized by the number 180). While improvements in efficiency may be realized by this latter approach, there are major drawbacks. For example, the service provider's computer may require special or proprietary software to communicate with and transfer information to, the claims coding, billing and processing agent's computer. Such processing applications can be both expensive to acquire, and are not always user-friendly. Nor is the software of the service provider and the coding, billing and processing agent always compatible. Further, such software may need to be frequently updated due to rapid changes in regulations and practices pertaining to claims coding, billing and processing. Additionally, such an approach may have limitations on the locations from which where the claims information may transferred, since only machines having the special application software can be used.

The problems and limitations of the prior art identified above are not limited to the traditional service provider model as shown above, but can be extended generally to any situation using an intermediary claims processing agent for the processing or pre-processing of any type of insurance claim (e.g., medical, dental, casualty, loss, liability, etc.), whether the entity filing the claim is a service provider (such as a hospital) or other type of claimant (e.g., individuals, insurance agents, etc.).

What is therefore needed but unavailable in the prior art is a claims coding, billing and processing system and method using an intermediary claims coding, billing and processing agent for automatically preparing the claim for processing when possible, and in which claim information can be transferred from almost any computer without the need for special application software, without the physical limitations associated with prior art methods, and without the costs associated with other previously-identified methods.

### SUMMARY

In view of the above-identified limitations of the prior art, the present invention provides an improved method of processing insurance claims. The method at least includes electronically gathering information comprising a first entity's insurance claim, connecting a front end first computer under the dominion of the first entity to a back end second computer under the dominion of a claims processing entity via the World Wide Web, transmitting an insurance claim from the first computer to the second computer, via the second computer via the World Wide Web, automatically processing the insurance claims, and via the claims processing entity, presenting processed insurance claims information to an insurer entity subsuming the responsibilities of deciding whether to pay a claim and payment of a claim.

### BRIEF DESCRIPTION OF THE DRAWINGS

Features of the present invention will become apparent to those skilled in the art from the following description with reference to the drawings, in which:

FIG. 1 is a schematic diagram of a prior art system for electronic claims processing;

FIG. 2 is a general schematic diagram of the present-inventive web-based electronic claims processing system; and

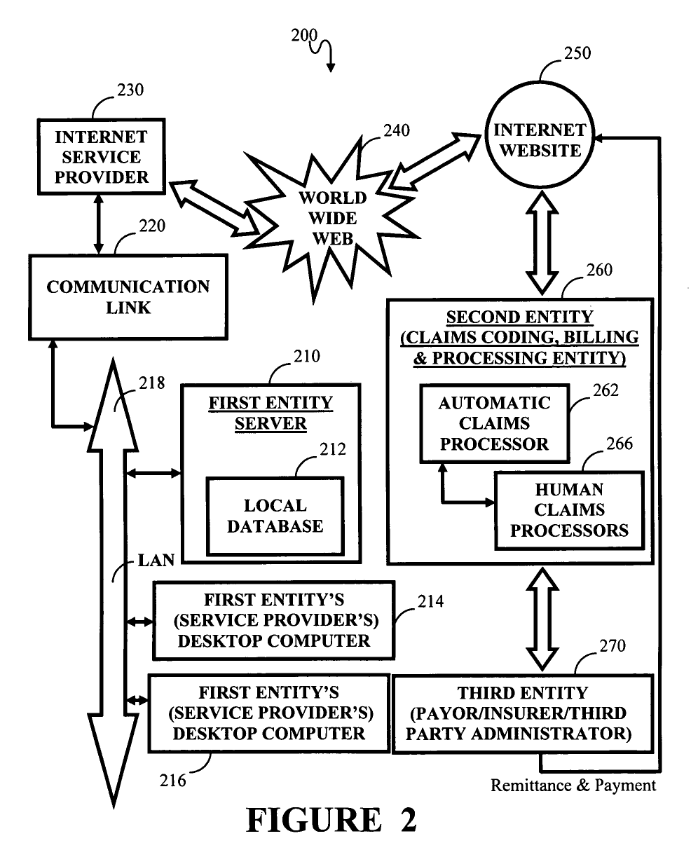

FIG. 3 is a general workflow diagram of the present-inventive method for electronic claims coding, billing and processing.

### DETAILED DESCRIPTION

General System

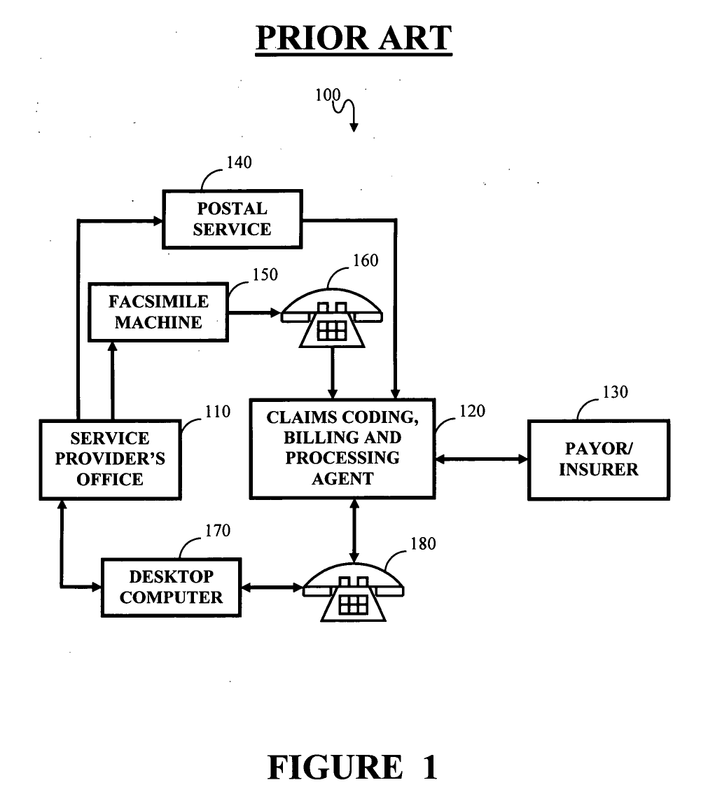

The present invention is a novel approach to coding, billing, preparing and processing claims on behalf of either a claims coder, claims submitter, claims processor, claims payor, claims payee, etc. The novel system 100 shown in FIG. 1 is probably more typical for a corporate setting with respect to the service provider, but those skilled in the art will appreciate that it can be modified for a non-corporate environment.

A Local Area Network (LAN) 218 provides functional connectivity for local networked components such as individual computers 214 and 216, and a server 210 managing a local database 212. When the service provider desires to have a claim coded, billed and processed by a claim coding, billing and processing entity 260, one of the computers containing or having access to the claim information is made to connect to the World Wide Web 240 via a communication link 220 and an Internet Service Provider 230. Those skilled in the art will appreciate that the system can be modified so that an external Internet Service Provider need not be needed to connect to the Internet. Those skilled in the art will also appreciate that the computers 210, 214 and 216 each contain or have access to a web browser capable of at least viewing and reproducing web pages in standard World Wide Web languages such as HTML (Hypertext Markup Language) and XML.

Through the web browser (not shown), the service provider computer operator can navigate to a website 250 maintained by the claims coding, billing and processing agent 260. Nominally, the preferred embodiment of the claims coding, billing and processing entity contains an automatic claims engine (“automatic claims processor”) 262, and a number of human claims processors 266. The automatic claims processor is a rules-based engine that can code, bill and process a received claim when the claim complies with predefined conditions, or request additional information or corrections from the service provider computer when necessary.

When the automatic claims engine 262 determines that a claim cannot be automatically processed (either before attempting to process it, or after processing has begun), the function of processing the particular claim suspends and then bails out to a human claims processor or reviewer 266 to handle the claim request. This allows the flexibility of having straightforward claims automatically processed for speed and precision, and having more involved claims to still be processed when needed.

Processed claims are presented to a third party payor or its agent 270 for final decisions and/or payments. An acknowledgement that an Electronic Data Interchange (EDI) submitted claim has been coded, billed, prepared or processed is sent to the service provider's computer via the World Wide Web, and the claim and results of the coding, billing or processing are forwarded to the payer/insurer institution.

It should be noted that communication and data transfer between the service provider and the claims coding, billing and processing entity is exclusively via the World Wide Web, thus making millions of computers capable of participating in the present-inventive system and method without the need for special or proprietary application software on the front end. This approach may also be applied to increase the ease and reduce the costs associated with submitting other non-medical claim types (e.g., automobile, worker's compensation, and direct consumer claims).

Algorithm Description

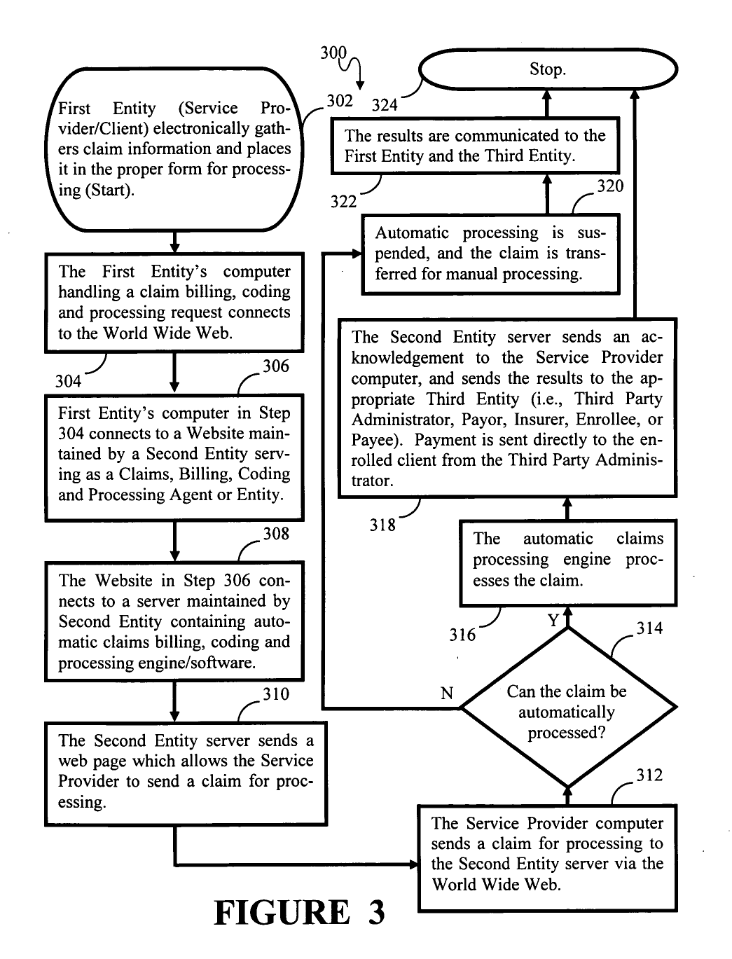

To begin the present-inventive remote claims coding, billing and processing method represented generally as the algorithm 300 in FIG. 3, the service provider electronically gathers information and places the information in a file or record constituting a claim (Step 302). The Service Provider connects to the World Wide Web via a computer in Step 304, including components well understood by those skilled in the art, such as a modem and a web browser. The Service Provider connects to a website under the dominion of the Claims Coding, Billing and Processing Entity for direct communication (Step 306).

The website communicates with a server maintained by the claims Coding, Billing and Processing Entity in Step 308. By presenting the appropriate web page to the Service Provider, the Claims Coding, Billing and Processing Entity is able to receive a request that a claim or claims be processed and adjudicated (Step 310). By appropriately navigating within the web page, the Service Provider computer can be made to send a claim to the Claims Coding, Billing and Processing Entity for processing (Step 312).

In the preferred embodiment, the claim information is already in a standard electronic form or format recognized by payor/insurance agencies. As such, transfer can be as simple as identifying a file to be copied and activating an icon to begin the transfer function. In Step 314, the automatic claims processing engine of the Claims Coding, Billing and Processing Entity server determines whether it can automatically process the claim. This includes such steps as determining whether adequate information is present in required fields, whether information is compliant with the form guidelines, and others.

If the claim can be automatically processed, the algorithm will proceed to Step 316, where the claim is automatically processed. Otherwise the algorithm jumps to Step 320. Upon automatically processing the claim, the Claims Coding, Billing and Processing Entity server sends an acknowledgement to the Service Provider computer that the claim has been processed, and further forwards the adjudicated or pending/suspended claim to the payor/insurer entity responsible for payment of the claim (Step 318).

In the preferred embodiment, claims unable to be automatically processed are bailed out to a human claims processing agent in Step 320. If a claim can be manually processed by the human claims coding, billing and payment processor, it is processed. Through the World Wide Web connection, the human claims processor can request further information or clarification as needed. The results of human processing can then be sent to both the Service Provider and the payor/insurer entity in Step 322. The algorithm stops in Step 324.

Variations and modifications of the present invention are possible, given the above description. However, all variations and modifications which are obvious to those skilled in the art to which the present invention pertains are considered to be within the scope of the protection granted by this Letters Patent.

For example, the type of claims capable of being processed by the present-inventive system and method are not limited to traditional medical, dental and optometrical/ophthalmological claims, but include, inter alia, liability, casualty, loss, theft, death benefits, disability, and worker's compensation or other subrogation type claims. The payor need not be limited to corporations and other business entities, but may also include government and quasi-government entities.

1. A method of processing insurance claims comprising:
a) electronically gathering information comprising a first entity's insurance claim;
b) connecting a front end first computer under the dominion of said first entity to a back end second computer under the dominion of a claims processing entity via the World Wide Web;
c) transmitting an insurance claim from said first computer to said second computer via the World Wide Web;
d) via said second computer, automatically processing said insurance claims; and
e) via said claims processing entity, presenting processed insurance claims information to an insurer entity subsuming the responsibilities of deciding whether to pay a claim and payment of a claim.

2. The method of claim 1, wherein said first entity is a service provider.

3. The method of claim 1, further comprising:
via said first computer and the World Wide Web, querying said second computer regarding the status of an insurance claim; and
providing insurance claim status information from said second computer to said first computer via said World Wide Web.

4. The method of claim 1, wherein presenting to an insurer entity is via the World Wide Web.

5. The method of claim 1, wherein step d) further comprises halting automatic processing when an insurance claim does not comply with a predefined criterion, and, via the World Wide Web, contacting said first entity.

6. The method of claim 1, wherein step d) further comprises halting automatic processing when an insurance claim does not comply with a predefined criterion, and referring a non-compliant claim to a human processor of the claims processing entity for further processing.

7. The method of claim 6, further comprising:
halting the processing by said human processor when the insurance claim still cannot be processed, and, via the World Wide Web, contacting said first entity.

8. The method of claim 1, wherein said insurance claim concerns medical services.

9. The method of claim 1, wherein said insurance claim concerns dental services.

10. The method of claim 2, wherein said service provider is a medical service provider, and said insurance claim concerns medical services.

11. The method of claim 2, wherein said service provider is a dental service provider, and said insurance claim concerns dental services.

12. The method of claim 1, wherein said insurance claim concerns a liability insurance claim.

13. The method of claim 1, wherein said insurance claim concerns a casualty claim.

14. The method of claim 1, wherein said insurance claim concerns a loss claim.

15. The method of claim 1, wherein said insurance claim concerns a theft claim.

16. The method of claim 1, wherein said insurance claim concerns a death benefits claim.

17. The method of claim 1, wherein said insurance claim concerns a worker's compensation claim.

18. The method of claim 1, wherein said insurance claim concerns a disability claim.
